(19) United States
(12) Patent Application Publication
(10) Pub. No.: US 2018/0015698 A1
(43) Pub. Date: Jan. 18, 2018

(54) ARC-SHAPED CELL PHONE SCREEN PROTECTOR

(71) Applicant: YONGDELI SILICONE RUBBER TECHNOLOGY (SHENZHEN) CO., LTD., Shenzhen, Guangdong (CN)

(72) Inventor: Denan Liao, Shenzhen, Guangdong (CN)

(21) Appl. No.: 15/306,760

(22) PCT Filed: Jul. 18, 2016
(86) PCT No.: PCT/CN2016/090259

§ 371 Date: Oct. 25, 2016

(51) Int. Cl. B32B 17/06; B32B 7/12

(52) U.S. Cl. CPC B32B 17/06; B32B 7/12; B32B 2457/20

(57) ABSTRACT

The present invention, pertaining to the field of cell phone accessories, provides an arc-shaped cell phone screen protector. The arc-shaped cell phone screen protector comprises a reinforced glass film layer and an adhesive layer; wherein the reinforced glass film comprises: a planar portion and a large arc-surface portion and a small arc-surface portion arranged to surround the planar portion, wherein the large arc-surface portion is arranged on left and right sides of the planar portion, the small arc-surface portion is arranged at top and bottom ends of the planar portion, and the large arc-surface portion and the small arc-surface portion both extend to the exterior of the cell phone screen. The technical solution according to the present invention has the advantage of effectively protecting the cell phone screen.

### TECHNICAL FIELD

The present invention relates to the field of cell phone accessories, and in particular, relates to an arc-shaped cell phone screen protector.

### BACKGROUND

Cell phones are commonly used electronic products in people's live. The current cell phones, especially emergence of Apple iPhone series smart phones, are greatly changing people's life style. With drastic development of the cell phones, the cell phones are being equipped with larger and larger screen, and are becoming thinner and thinner. In this case, the screens of the cell phones is fragile, especially the screens of the iPhone 6 Plus series cell phones. To prevent the screens from being broken and scratched, screen protectors are generally pasted on the screens, which not only protect the screens but also do not affect the appearance and use of the cell phones. Due to wide application of the cell phone screen protectors, substantially all the smart phones, especially large-screen cell phones are pasted with screen protectors.

During implementation of the technical solution in the related art, it is found that the related art has the following technical problem:

The cell phone screen protector is planar and flat, and thus is capable of only protecting the screen from being scratched. However, the cell phone screen protector fails to effectively protect the screen thereof. If the cell phone drops down, the screen thereof is easily broken.

### SUMMARY

Embodiments of the present invention are intended to provide an arc-shaped cell phone screen protector, to solve the problem in the conventional technical solution that the cell phone screen is easily broken.

In one aspect, an arc-shaped cell phone screen protector is provided. The arc-shaped cell phone screen protector comprises a reinforced glass film layer and an adhesive layer; wherein the reinforced glass film comprises: a planar portion and a large arc-surface portion and a small arc-surface portion arranged to surround the planar portion, wherein the large arc-surface portion is arranged on left and right sides of the planar portion, the small arc-surface portion is arranged at top and bottom ends of the planar portion, and the large arc-surface portion and the small arc-surface portion both extend to the exterior of the cell phone screen.

Optionally, that the large arc-surface portion and the small arc-surface portion both extend to the exterior of the cell phone screen indicates that the large arc-surface portion and the small arc-surface portion both extend out of the cell phone screen by 0.1 mm.

Optionally, the large arc-surface portion is a radius greater than 0.1 mm and less than 0.15 mm, and the small arc-surface portion is a radius of 0.1 mm.

According to the embodiments of the present invention, the arc-shaped cell phone screen protector has four arc surfaces, wherein the arc surfaces wrap the entire cell phone screen. In this way, when the cell phone drops down, the arc surfaces thereof firstly suffer from the force. As such, the cell phone screen would not be broken, and therefore the arc-shaped cell phone screen protector effectively protects the cell phone screen.

### BRIEF DESCRIPTION OF THE DRAWINGS

FIG. 1 is a front view of an arc-shaped cell phone screen protector according to one embodiment of the present invention; and

FIG. 2 is a front view of an arc surface of the arc-shaped cell phone screen protector according to one embodiment of the present invention.

### DETAILED DESCRIPTION

In order to make the objectives, technical solutions, and advantages of the present invention clearer, the present invention is further described in detail below by reference to the embodiments and the accompanying drawings. It should be understood that the embodiments described here are only exemplary ones for illustrating the present invention, and are not intended to limit the present invention.

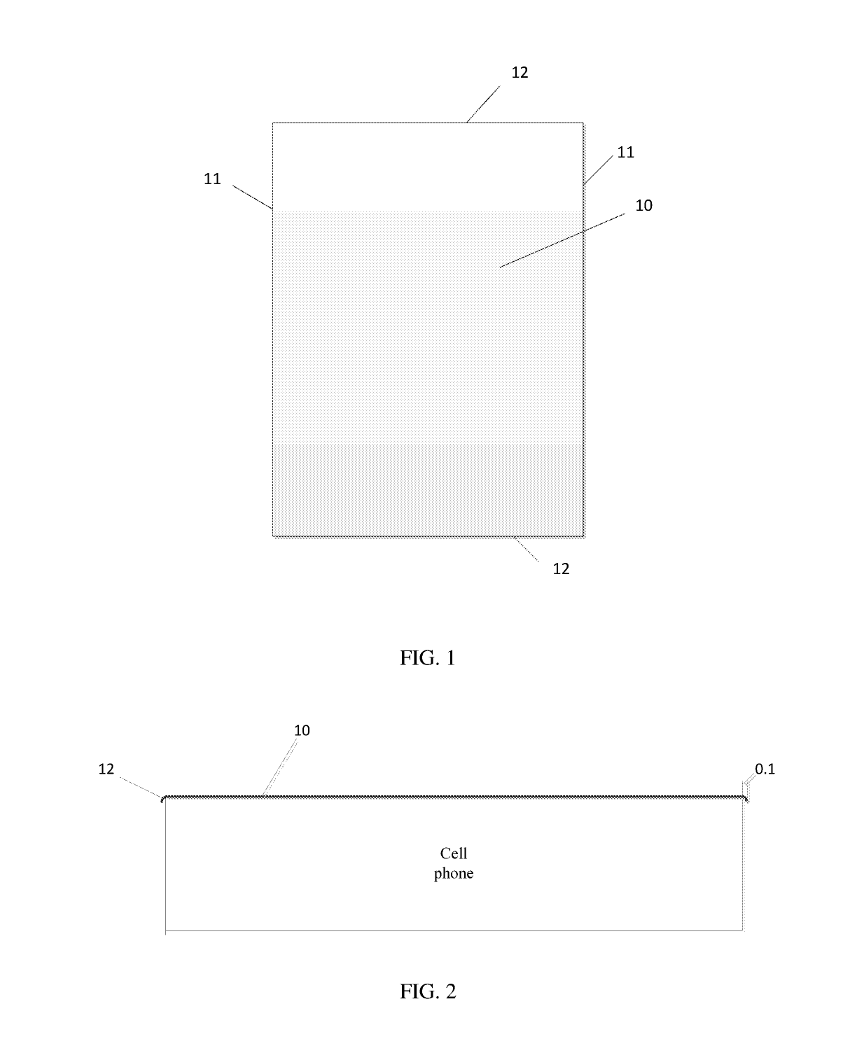

Referring to FIG. 1, FIG. 1 is a front view of an arc-shaped cell phone screen protector according to one embodiment of the present invention. The arc-shaped cell phone screen protector comprises a reinforced glass film layer and an adhesive layer; wherein the reinforced glass film comprises: a planar portion 10 and a large arc-surface portion 11 and a small arc-surface portion 12 arranged to surround the planar portion 10, wherein the large arc-surface portion 11 is arranged on left and right sides of the planar portion 10, the small arc-surface portion 12 is arranged at top and bottom ends of the planar portion 10, and the large arc-surface portion 11 and the small arc-surface portion 12 both extend to the exterior of the cell phone screen.

The arc-shaped cell phone screen protector according to the present invention has four arc surfaces, wherein the arc surfaces wrap the entire cell phone screen (that is, the four arc surfaces all extend to the exterior of the cell phone screen). In this way, when the cell phone drops down, the arc surfaces thereof firstly suffer from the force. As such, the cell phone screen would not be broken, and therefore the arc-shaped cell phone screen protector effectively protects the cell phone screen.

Optionally, that the large arc-surface portion 11 and the small arc-surface portion 12 both extend to the exterior of the cell phone screen indicates that the large arc-surface portion 11 and the small arc-surface portion 12 both extend out of the cell phone screen by 0.1 mm. Such configuration is to prevent an over-large size of the extended portion which may affect the lamination degree of the cell phone screen protector. With respect to the cell phone screen protector, if the lamination is not sufficient, bubbles may appear, which affect the aesthetic degree thereof.

Optionally, the large arc-surface portion 11 is a radius greater than 0.1 mm and less than 0.15 mm, and the small arc-surface portion 12 is a radius of 0.1 mm.

The above descriptions are merely preferred embodiments of the present invention, but not intended to limit the present invention. Any modification, equivalent replacement, and improvement made without departing from the spirit and principle of the present invention shall fall within the protection scope of the present invention.

What is claimed is:

1. An arc-shaped cell phone screen protector, comprising a reinforced glass film layer and an adhesive layer; wherein the reinforced glass film comprises: a planar portion and a large arc-surface portion and a small arc-surface portion arranged to surround the planar portion, wherein the large arc-surface portion is arranged on left and right sides of the planar portion, the small arc-surface portion is arranged at top and bottom ends of the planar portion, and the large arc-surface portion and the small arc-surface portion both extend to the exterior of the cell phone screen.

2. The arc-shaped cell phone screen protector according to claim 1, wherein that the large arc-surface portion and the small arc-surface portion both extend to the exterior of the cell phone screen indicates that the large arc-surface portion and the small arc-surface portion both extend out of the cell phone screen by 0.1 mm.

3. The arc-shaped cell phone screen protector according to claim 1, wherein the large arc-surface portion is a radius greater than 0.1 mm and less than 0.15 mm, and the small arc-surface portion is a radius of 0.1 mm.
